(19) United States
(12) Patent Application Publication
(10) Pub. No.: US 2016/0045982 A1
(43) Pub. Date: Feb. 18, 2016

(54) HYBRID WELDING/PRINTING PROCESS

(71) Applicant: Siemens Energy, Inc., Orlando, FL (US)

(72) Inventors: Kyle I. Stoodt, Houston, TX (US); Timothy D. Rash, Houston, TX (US); Brandon W. Shinn, Houston, TX (US)

(21) Appl. No.: 14/461,467

(22) Filed: Aug. 18, 2014

(51) Int. Cl. B23K 26/28; B23K 26/32; B23K 26/34; F01D 5/00

(52) U.S. Cl. CPC B23K 26/28; F01D 5/005; B23K 26/3206; B23K 26/34; F05D 2230/234; F05D 2300/175; F05D 2300/174; F05D 2230/31

(57) ABSTRACT

A method (50) of installing a tip cap (42) onto a turbine blade (20). An open tip is prepared (52) by removing a tip cap from a used blade or during original blade manufacture. A tip cap base sheet (24) is formed (54) to cover at least most of the blade tip surface except for a margin (22). A root pass weld (28) is performed (58) around the periphery of the base sheet, thus welding the base sheet onto the blade tip surface. Cladding (34) is applied (60) to the base sheet and the blade tip surface, thus building and fusing the tip cap onto the blade tip, the tip cap formed of cladding and the base sheet. A squealer ridge (44) may then be formed on the tip cap by additive welding.

### FIELD OF THE INVENTION

This invention relates generally to the fields of metals joining and filler manufacture and, more particularly, to a process for building a tip cap on a turbine blade by additive welding.

### BACKGROUND OF THE INVENTION

Worn gas turbine blade tip caps can be replaced by grinding the old cap away and installing a new one on the blade tip. However, gas turbine blades are often made of a superalloy for heat tolerance, and installing a superalloy blade tip cap by a known process is difficult and time-consuming. In one process, the worn tip cap is removed, and a superalloy tip cap is welded to the blade tip in a hot box. An existing version of this process takes about 24 hours per blade, partly due to slow heating in the hot box, and gradual cooling required in order to minimize cracking of the superalloy material. In spite of precautions, this process often produces cracks that must be manually corrected. Similar issues arise when installing a tip cap on a newly manufactured blade when fixturing of a ceramic core prevents the casting of a closed blade tip during the primary casting process.

Superalloy materials are among the most difficult materials to weld due to their susceptibility to weld solidification cracking and strain age cracking. The term “superalloy” as used herein means a highly corrosion and oxidation resistant alloy with excellent mechanical strength and resistance to creep at high temperatures. Superalloys typically include high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

FIG. 1 is a chart illustrating the relative weldability of various alloys as a function of their aluminum and titanium content. Alloys such as Inconel® 718 which have relatively lower concentrations of these elements, and consequentially relatively lower gamma prime content, are considered relatively weldable. Alloys such as Inconel® 939 which have relatively higher concentrations of these elements are generally considered to be difficult to weld and require special procedures which minimize the heat input of the process. For purposes of discussion herein, the dashed line 19 indicates a border between a zone of weldability below the line 19 and a zone of non-weldability above the line 19. The line 19 intersects 3 wt. % aluminum on the vertical axis and 6 wt. % titanium on the horizontal axis. Within the zone of non-weldability, the alloys with the highest aluminum content are generally found to be the most difficult to weld. United States patent application publication number US 2013/0140278 A1, commonly owned with this application and incorporated by reference herein, discloses a new process for the weld deposition of these difficult to weld materials.

United States patent application publication number US 2013/0298400 A1, also commonly owned with this application, describes a method of repairing a turbine blade tip which uses a specially shaped tip cap in order to minimize welding stresses during installation. Further improvements are desired.

### BRIEF DESCRIPTION OF DRAWINGS

The invention is explained in the following description in view of the drawings that show:

FIG. 1 is a chart illustrating relative weldability of various superalloys.

FIG. 2 is a top view of a turbine blade tip without a cap.

FIG. 3 is a top view of a turbine blade with a tip cap base sheet thereon.

FIG. 4 is a sectional view taken along line 4-4 of FIG. 3 illustrating the tip cap base sheet and a periphery root weld.

FIG. 5 illustrates a cladding process adding metal layers on the base sheet.

FIG. 6 shows an example of a laser scan pattern for a cladding layer.

FIG. 7 shows an additive welding tip cap fused to the blade tip surface.

FIG. 8 shows squealer ridges added around the periphery of the blade tip cap.

FIG. 9 illustrates aspects of a method of the invention.

### DETAILED DESCRIPTION OF THE INVENTION

The present inventors created a hybrid welding/printing process that is faster and more dependable than prior methods for building a tip cap on a turbine blade for worn tip cap replacement or for original blade manufacture. The inventive process combines the concepts of welding a pre-formed blade tip with an additive manufacturing process. The inventors recognized that the welding of a full size blade tip cap can create a high level of stress in the component, and they minimize such stresses by initially welding only a thin base sheet of metal onto the blade tip. Subsequently, a full thickness of the tip cap is created by applying successive thin layers of metal over the base sheet with a powder deposition process using controlled laser heating. The result is the fabrication of a thick blade tip cap while avoiding the build-up of stresses to a level where cracking is a hindrance to productivity.

FIG. 2 is a top view of a conventional turbine blade tip 20 without a cap. This condition exists on a used blade after removal of a degraded cap for replacement and on a newly cast blade prior to building a tip cap. The blade has a leading edge LE, trailing edge TE, pressure and suction side walls PS, SS with an upper surface 22, where “upper” or “top” or “tip” means radially distal from the turbine axis when installed. The blade may have internal partitions defining cooling chambers as known (not shown).

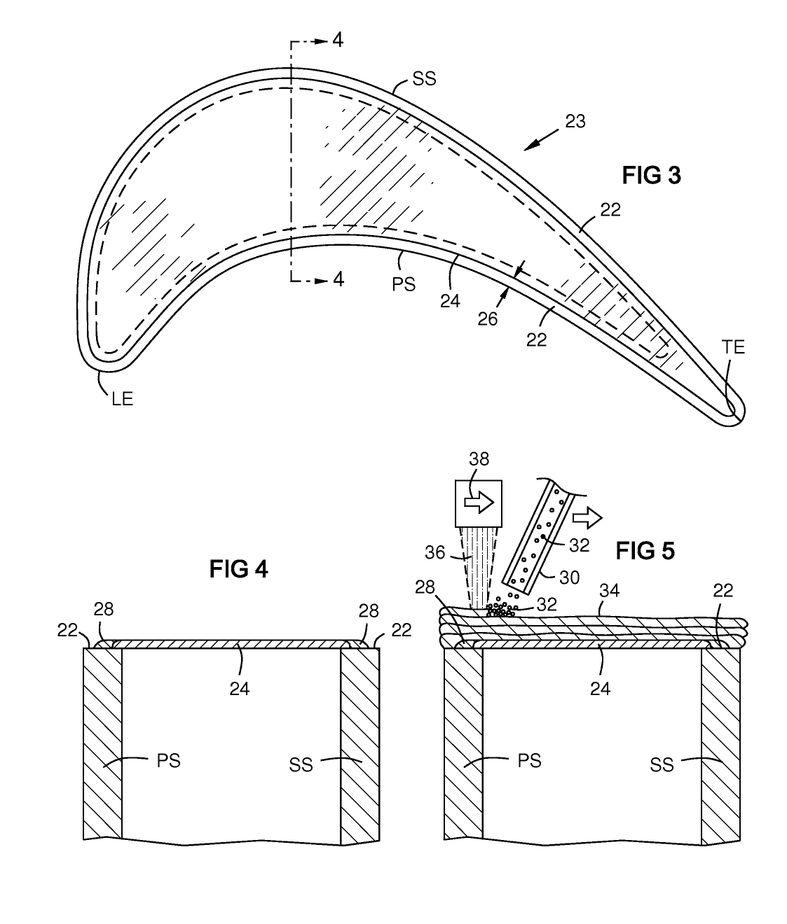

FIG. 3 is a top view of a turbine blade 23 with a thin sheet of metal 24, for example about 0.03-0.08 inches thick. It may be just thick enough to support cladding with fusion thereto without sagging. It may be shaped to cover at least most of the blade tip surface 22. For example it may cover all of the blade tip surface except for a margin 26 around the sheet. A weld root pass is performed around the periphery of the tip cap base sheet 24, welding it to the tip surface 22. The base sheet may be tack-welded to the blade tip prior to the root pass.

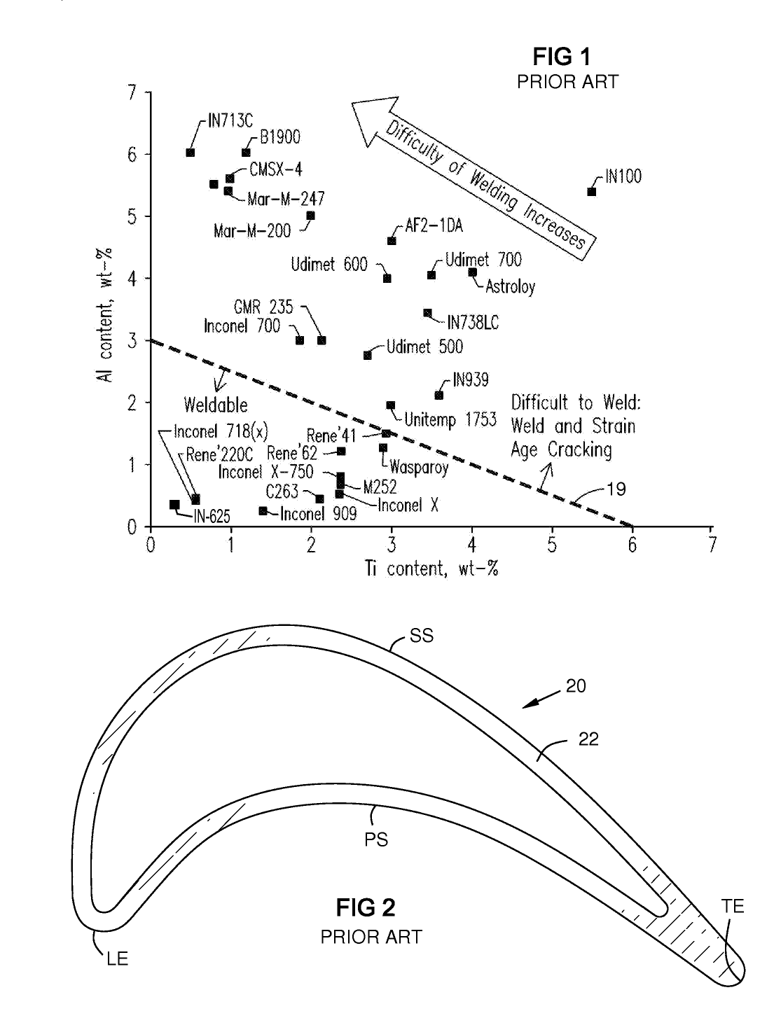

FIG. 4 is a sectional view taken along line 4-4 of FIG. 3 showing a tip cap base sheet 24 and a root weld 28. The base sheet 24 may be made of a material similar to, or the same as, the blade material. The material of the base sheet may be a superalloy above the line of weldability 80 in FIG. 1, for example Inconel® 738. The root weld 28 may be made of a more ductile material, which may be on or below the line of weldability, for example Inconel® 625, to mitigate stress along the sheet periphery/tip surface intersection and the root weld.

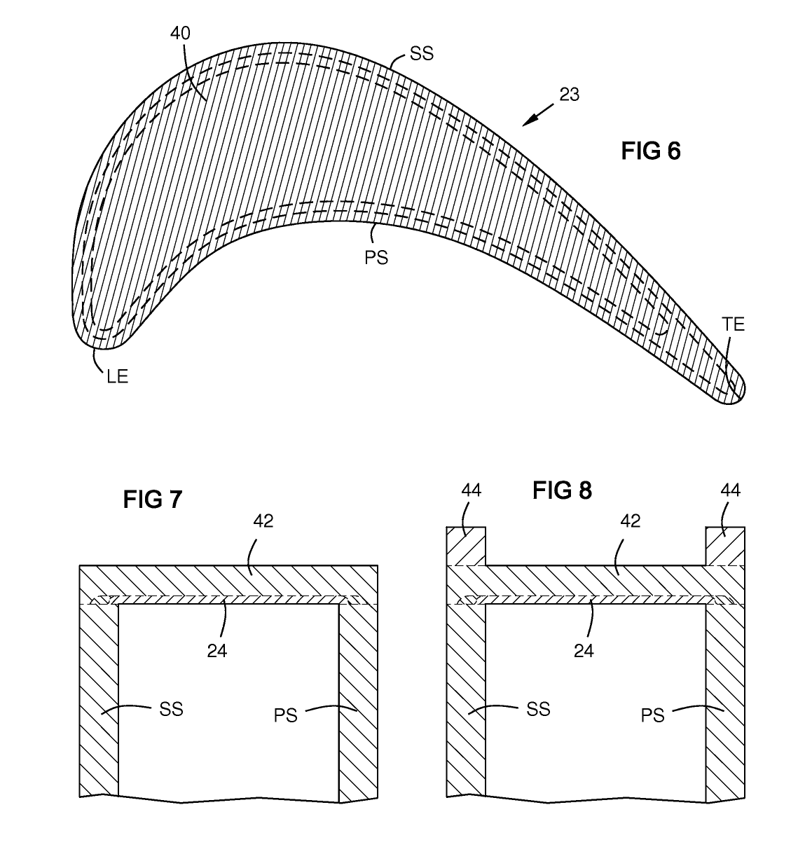

FIG. 5 illustrates a cladding process in which a cladding filler distribution apparatus 30 feeds a filler material 32 onto the tip cap base sheet 24 and onto subsequent layers of cladding 34. The filler material 32 contains the material or constituents thereof for the tip cap, and may also contain a flux material. The filler material may be in powder form. A laser beam 36 or other directed energy beam is traversed 38 over the filler material 32. In other embodiments the powder may be fed coaxially with the laser beam 36. Preparatory grinding and finishing may be done prior to cladding in an automated CNC grinding machine. Welding and cladding may be done in an automated laser welder and cladding system. U.S. patent application Ser. No. 13/936,482 published as US 2014/0069893 A1, commonly owned with the present application, teaches a laser cladding process and is incorporated by reference herein.

Using a powder feed apparatus and method as shown allows unattended operation over multiple layers. This cladding operation has been performed automatically in a Huffman® laser welder and cladding system in about 1 hour to clad six to eight layers on a Siemens SGT6-6000G row 2 turbine blade. The tip cap edges are then machined flush with the blade exterior surface, and the cladding may be machined to a final thickness. Any desired thickness of multi-layer cladding 34 may be applied over the tip cap base sheet 24, and in one embodiment the cladding 34 may be twice as thick as the base sheet 24, and in another embodiment may range from about 0.03-0.20 inches. The base sheet functions as scaffolding that supports the cladding. The first layer of cladding fuses to the base sheet and to the tip surface 22. Each successive layer of cladding fuses to a previous cladding layer. The cladding conforms to each surface as it builds, providing relatively low process stress and a more integrated blade tip with lower operational stress than in prior methods of welding a full-thickness tip cap onto the blade tip.

FIG. 6 shows an example of a laser path pattern 40 for a cladding layer. The beam energy intensity and scan speed may be varied over the surface as needed to provide fusion with minimal melting and stress of the substrate. Adjacent cladding layers may use different angles of approach or opposite scan directions to reduce the occurrence of voids.

FIG. 7 shows a tip cap 42 after building as above. It is fused to the top surfaces of the blade walls PS, SS. The base sheet 24 is fused with the cladding that forms the remainder of the tip cap. The sides of the tip cap are machined flush with the exterior surfaces of the blade.

FIG. 8 shows squealer ridges 44 extending radially around the periphery of the blade tip cap. They may be formed by further additive welding. In one embodiment it may be made of a material that is the same as, or similar to, that of the tip cap or component base material. This addition can be done for example by further laser cladding in a Huffman® laser welder and cladding system followed by machine finishing.

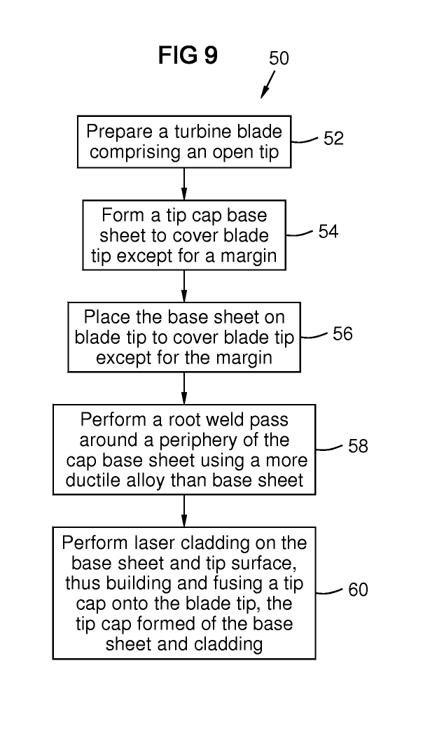

FIG. 9 illustrates a method 50 of an embodiment of the invention, including the following steps:

52—Prepare a turbine blade comprising an open tip, such as by grinding off a used tip to a smooth, planar surface;

54—Form a tip cap base sheet to cover the blade tip except for a margin;

56—Place the base sheet on the blade tip to cover the blade tip except for the margin;

58—Perform a root weld pass around a periphery of the base sheet using a more ductile alloy than that of the base sheet;

60—Perform laser cladding on the base sheet and tip surface, thus building and fusing a tip cap onto the blade tip, the tip cap formed of the base sheet and cladding.

The method described herein takes 3-5 hours to complete after the old tip cap is removed. In contrast, a prior method of tip cap replacement in a hot box takes about 24 hours. Argon consumption is much less with the new method, for example using a Huffman® laser welder and cladding system, compared to the prior hot box method. The new method provides more consistent and reliable results. Thus, the method herein is much faster, more reliable, and more efficient than prior methods.

While various embodiments of the present invention have been shown and described herein, it will be obvious that such embodiments are provided by way of example only. Numerous variations, changes and substitutions may be made without departing from the invention herein. For example, the hybrid process described herein may be used on components other than turbine blades and may be used for joining any two substrates with a cap where welding a full thickness of the cap would produce undesirable levels of stress in the base material. Accordingly, it is intended that the invention be limited only by the spirit and scope of the appended claims.

The invention claimed is:

1. A method comprising:
preparing a turbine blade comprising an open blade tip;
forming a tip cap base sheet to cover at least a portion of the blade tip;
placing the base sheet to cover said at least a portion of the blade tip;
performing a root pass weld around a periphery of the base sheet, welding the base sheet onto surfaces of the blade tip; and
cladding the base sheet and the blade tip surfaces with metal layers, forming the tip cap comprising cladding fused to the base sheet.

2. The method of claim 1, wherein the turbine blade is made of a superalloy composition that is outside a zone of weldability defined on a graph of superalloys plotting titanium content verses aluminum content, wherein the zone of weldability is upper-bounded by a line intersecting the titanium content axis at 6 wt. % and intersecting the aluminum content axis at 3 wt. %, and further comprising:
forming the tip cap base sheet of a superalloy composition that is outside the zone of weldability; and
performing the root pass weld with a weld material that is within the zone of weldability.

3. The method of claim 2, further comprising cladding the base sheet with a superalloy composition that is outside the zone of weldability.

4. The method of claim 1, wherein the cladding is deposited to a thickness of at least twice a thickness of the base sheet.

5. The method of claim 2, wherein the turbine blade is degraded from use, and the preparing step further comprises removing a degraded tip cap from the turbine blade, leaving the open blade tip.

6. The method of claim 1, further comprising forming a radially extending squealer ridge around a periphery of the tip cap by additive welding.

7. The method of claim 1, wherein the cladding is performed by scanning a laser beam to melt a feed material over a substrate formed by a surface of the blade tip and the base sheet thereon, and over substrates subsequently formed by each successive metal layer of the cladding, and the laser beam is disposed at different approach angles for respectively different layers of the cladding.

8. A method comprising:
preparing a turbine component comprising an opening;
forming a cap base sheet to cover the opening except and defining a margin around a periphery of the base sheet;
positioning the base sheet over the opening;
performing a root pass weld around the periphery of the base sheet, thus welding the base sheet onto a surface of the component; and,
cladding the base sheet and a component surface in the margin with mutually fused metal layers, thus forming a cap comprising cladding and the base sheet, wherein the cladding is at least twice as thick as the base sheet.

9. The method of claim 8, wherein the component is made of a superalloy composition that is outside a zone of weldability defined on a graph of superalloys plotting titanium content verses aluminum content, wherein the zone of weldability is upper-bounded by a line intersecting the titanium content axis at 6 wt. % and intersecting the aluminum content axis at 3 wt. %, and further comprising:
forming the base sheet of a superalloy composition that is outside the zone of weldability; and
performing the root pass weld with a weld material that is within the zone of weldability.

10. The method of claim 9, further comprising, forming the base sheet of the same superalloy composition as the component.

11. The method of claim 9, further comprising cladding the base sheet and component surface with a superalloy composition that is outside the zone of weldability.

12. The method of claim 8, wherein the component is degraded from use, and the preparing step further comprises removing a degraded portion from the component.

13. The method of claim 8, further comprising forming a radially extending ridge around a periphery of the cap by additive welding.

14. The method of claim 9, wherein the cladding is performed by scanning a laser beam over a substrate formed by the surface of the component and the base sheet thereon and subsequently formed by each successive metal layer of the cladding, while feeding a feed material onto the substrate ahead of the laser beam, and the laser beam is disposed at different approach angles for respectively different layers of the cladding.

15. A method comprising:
welding a base sheet to span an opening of a component; and
cladding successive layers of metal over the base sheet to form a desired thickness of a cap over the opening.

16. The method of claim 15, wherein a thickness of the base sheet is no more than a third of a thickness of the cap.

17. The method of claim 15, wherein the component is a turbine blade and the cap forms a tip cap of the blade.
